(19) United States
(12) Patent Application Publication
(10) Pub. No.: US 2016/0252271 A1
(43) Pub. Date: Sep. 1, 2016

(54) DEVICE FOR TREATMENT OF LIQUID IN A LIQUID FLOW SYSTEM, METHOD AND USE HEREOF

(71) Applicant: LIQUIDA TEC APS, Vejle (DK)

(72) Inventor: Martin Nielsen, Bramming (DK)

(21) Appl. No.: 15/033,603

(22) PCT Filed: Nov. 1, 2013
(86) PCT No.: PCT/DK2013/050353

§ 371 Date: Apr. 29, 2016

(51) Int. Cl. F24H 1/10; F24H 9/00; H05B 1/02; H05B 3/03; H05B 3/78

(52) U.S. Cl. CPC F24H 1/106; H05B 3/03; H05B 3/78; H05B 1/0297; F24H 9/001

(57) ABSTRACT

The invention relates to a device for treatment of a liquid in a liquid flow system. The device comprises a housing with at least a liquid inlet and outlet for accompanying a liquid flow through the housing, at least one AC voltage source alternating at a switch frequency, at least a first and second electrode with electric connections to said at least one AC voltage source and control means for controlling the level of treatment of the liquid. The at least a first and second electrode and control means are at least partly located in said liquid flow of said housing. The invention also relates to a method of treating a liquid in a liquid flow system and use of the device and method in a through-flow electric liquid heating system or a liquid purification system.

### BACKGROUND OF THE INVENTION

The present invention relates to a device for treatment of liquid in a liquid flow system, method and use hereof.

Devices for treading water in a through-flow application are known within the technical field e.g. electric water heaters for instantly heating water as it flows through the heaters.

The known electric water heaters may use different electric principles for agitating positive and negative ions in the water of the water flow such as capacitive or inductive means.

FIG. 1 illustrates an embodiment of an electric water heater using capacitive means by applying an AC voltage to two electrodes located in the water flow. The AC voltage alternates with a switch frequency agitating the positive and negative ions of the water to move toward the positive and negative electrodes, respectively. The ions will alter direction with the change in electrode polarities from the switch frequency.

The resulting friction of the moving ions will heat the water wherein the heating process may be controlled by changing one or more electric values such as the value of the AC voltage and/or the switch frequency.

A problem with the known electric water heaters is the complexity of the system necessary for controlling the heating process in the water heaters e.g. a control system for a water heater involving controllers for changing the voltage and/or frequency values in response to detected water values.

The complexity of the control system will also affect the size and cost of the electric water heater.

An object of the invention is to provide a device for treatment of liquid in a liquid flow without the above problems or disadvantages.

### The Invention

The invention relates to a device for treatment of a liquid in a liquid flow system, said device comprising

a housing with at least a liquid inlet and outlet for accompanying a liquid flow through the housing,

at least one AC voltage source alternating at a switch frequency,

at least a first and second electrode for treatment of said liquid and with electric connections to said at least one AC voltage source, and

moveable control means for controlling the level of liquid treatment

wherein said at least a first and second electrode and control means are at least partly located in said liquid flow.

Hereby is obtained a device which controls the level of liquid treatment by directly changing the interaction between the electrodes via the flowing liquid instead of an indirect control of electric values applied to the electrodes.

The liquid may be water in a drinking water system but may also be contaminated or infected water e.g. in ballast tanks of a ship. The liquid treatment of the latter type of water may for example be necessary according to national or international conventions in order to discharge the water into the sea.

Further, the liquid may be different types of oil e.g. edible oils which need treatment for removing any contaminations or heavy fuel/bunker oils which need treatment to increase the oil temperature to make it more flowable.

Even further types of liquid may be used in the device according to the invention such as organic liquids, i.e. blood, meet in pulp form etc. as long as the liquid is electrically conductive.

The term “treatment of liquid” should be understood as changing a value of the liquid in order to makes the liquid more acceptable and useful for an end-user of the liquid. The liquid treatment may for example include an increase of a temperature value or a reduction of a liquid contaminant value of the liquid flowing through the device.

In an aspect of the invention, said control means comprises at least one dividing element made in an electrically isolating material. The dividing element or elements will restrict the flow of ions or move away the ions from the flowing liquid when the dividing element is located fully or partially between the electrodes. Hereby it is possible to control the treatment of the liquid flowing through the device e.g. controlling the degree of liquid heating.

Alternatively, the dividing element is made in an electrically conductive material and is applied to enhance the flow of ions in the flowing liquid when the dividing element is located fully or partially between the electrodes.

In another aspect of the invention, said dividing element is concentrically surrounding at least a part of one electrode of said at least a first and second electrode. Hereby is achieved a compact and thin design of the housing and control means.

In an aspect of the invention, said control means comprises a control rod or similar mechanical device extending out of the housing for controlling the position of said dividing element. Hereby is achieved a simple and reliable control of the liquid treatment. A user can easily perform the control of the device by moving the control rod and dividing element to a new position and instantly—for example—detect a temperature change in a flow of drinking water.

In an aspect of the invention, one electrode of said at least a first and second electrode is hollow and holding said control rod for interaction with said dividing element via permanent magnets on the rod and/or element. The hollow structure allows a device with a thin and compact design by the efficient use of the space. Further, the use of permanent magnets in establishing a contactless connection between the different means ensures a more durable device by reducing the number of mechanical interactions in the flowing liquid.

In an aspect of the invention, said moveable control means comprises said at least first electrode and/or said second electrode displaceable in relation to each other. The displacement of one electrode in relation to the other stationary electrode or displacement of both electrodes ensures a direct, simple and swift control.

In an aspect of the invention, said housing is at least separated in a treatment part and a control means part. The separation in parts allows the device to be built with a slim housing design as well as ensures that the control means do not interfere with the liquid flow and treatment in the treatment part when retracted into the control means part.

In an aspect of the invention, said control means performs linearly or circularly motions e.g. a linear sliding motion of said dividing element and/or a circular displacement of said at least a first and second electrode. The linear motion allows the device to be built with a slim housing design as mentioned above. A circular motion by control means ensures a direct and swift control e.g. if one or both electrodes are rotated in order to overlap more or less.

In an aspect of the invention, said switch frequency is a value of at least 10 kHz such as approx. 30 kHz. The exposure of the liquid to an electrode voltage with a significantly high switch frequency ensures that liquid containment such as any volumes of virus, bacteria and/or amoeba or any other organic matter carrying a DNA in the liquid flow may be reduced or even removed. Possible causes of diseases will hereby also be reduced in—for example—drinking water by killing dangerous virus, bacteria and/or amoebas in the water with the electric liquid treatment. Furthermore, unwanted organic material in ballast water can be eliminated in an efficient manner. An effective liquid treatment only requires a minor electric energy supply from the electrodes of the device in order to reduce liquid containment and the resulting heating of the flowing liquid may hereby be insignificantly such as less than 5° C. and preferably less than 2 to 3° C.

The device according to the invention may in a particular embodiment comprise an arrangement for controlling the movement of the moveable control means in response to an operational parameter of the device, such as the electric current through the electrodes, the temperature of the liquid after treatment and/or the flow rate of liquid through the device.

The invention also relates to a method of treating liquid in a liquid flow system with a device for treatment of liquid according to any of claims 1 to 9, said method comprises the steps of:

providing a path for a liquid flow in the housing of the device via at least a liquid inlet and outlet of the housing,

connecting at least one AC voltage source to at least a first and second electrode for treatment of the liquid in said device, and

controlling the level of liquid treatment with control means,

wherein said at least a first and second electrode and control means are at least partly located in the liquid flow of said housing.

Hereby is achieved an advantageous method according to the invention of treating a liquid.

Further, the invention relates to use of a device for treatment of a liquid according to any of claims 1 to 9 and/or a method of treating liquid according to claim 10 in a through-flow electric liquid heating system or liquid purification system.

The two preferred systems allow for advantageous uses of the claimed device and/or method for treatment of a liquid such as drinking water.

### FIGURES

The invention will be described in the following with reference to the figures in which

FIG. 1 illustrates a well-known device for treading water in a water flow system including an enlargement of a water flow,

FIG. 2 illustrates an embodiment of a device according to the invention for treatment of liquid,

FIG. 3 illustrates an enlargement of the control means in the device of FIG. 2,

FIGS. 4a and 4b illustrate different positions of the control means in FIG. 2 in relation to the electrodes of the device,

FIG. 5 illustrates a perspective cross sectional view of an embodiment of the device according to the invention for treatment of liquid with control means,

FIG. 6 illustrates an alternative embodiment of the device according to the invention for treatment of liquid, and

FIG. 7 illustrates the embodiment of FIG. 6 with a controller to control the position of the second electrode with respect to the first electrode.

### DETAILED DESCRIPTION OF THE INVENTION

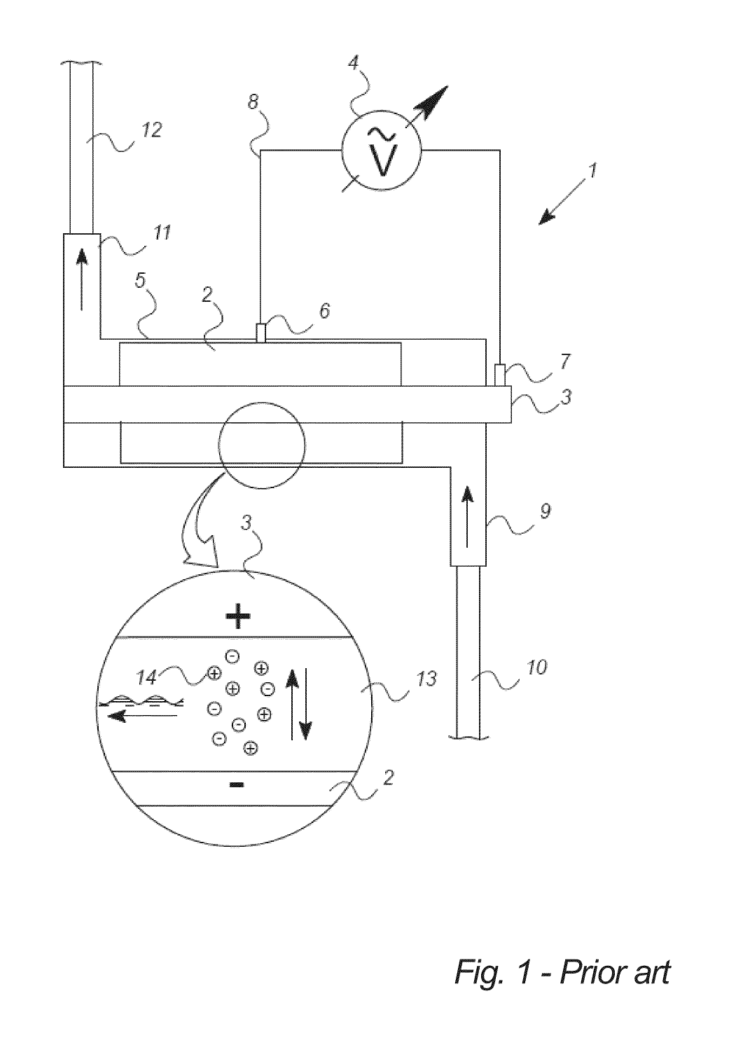

FIG. 1 illustrates a well-known device 1 for heating water in a water flow system including an enlargement of a water flow.

The electric water heater 1 comprises a housing 5 with a water inlet and outlet 9, 11 for connection to a supply pipe 10 and discharge pipe 12 of a water flow system (not illustrated) e.g. a system for supplying a flow of drinking water.

The electric water heater 1 use capacitive means by applying an AC voltage 4 to two concentric electrodes 2, 3 located in the water flow 13 via electric connections 6-8. The concentric electrodes have different radius and the electrode 2 with the larger radius surrounds the smaller electrode 3 in a part of the housing.

The AC voltage may alternate with a switch frequency agitating the positive and negative ions 14 of the water to move toward the positive and negative electrodes, respectively, as schematically illustrated in the figure enlargement. The ions will alter direction with the change in electrode polarities from the switch frequency. The AC voltage 4 is illustrates in the figure as at least a variable voltage source.

The water flow 13 is directed through the housing 5 of the electric water heater 1 from inlet 9, between the two electrodes 2, 3 wherein the ions 14 are agitated to achieve heating of the flowing water, and finally to the outlet 11.

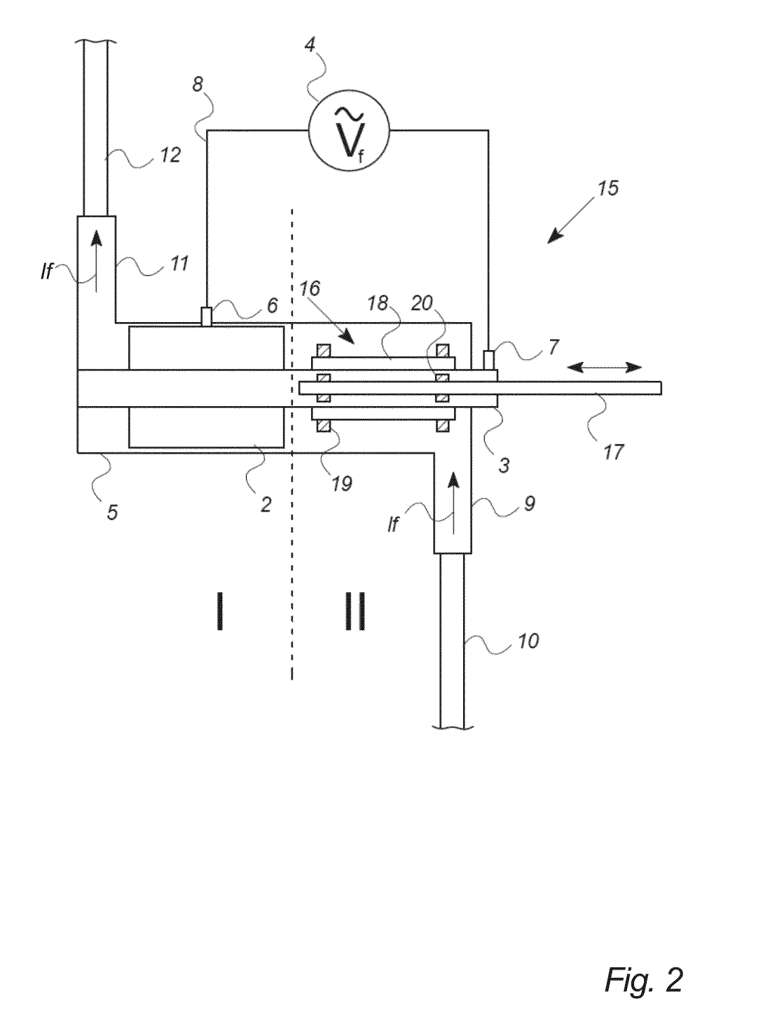

FIG. 2 illustrates a cross sectional view of an embodiment of a device 15 according to the invention for treatment of liquid.

The device 15 is illustrated with a first and second part inside the housing 5—a treatment part I and a control means part II. The device comprises liquid inlet and outlet 9, 11 as well as an AC voltage 4 connected to the electrodes 2, 3. The AC voltage is illustrated in the figure as a non-variable voltage source.

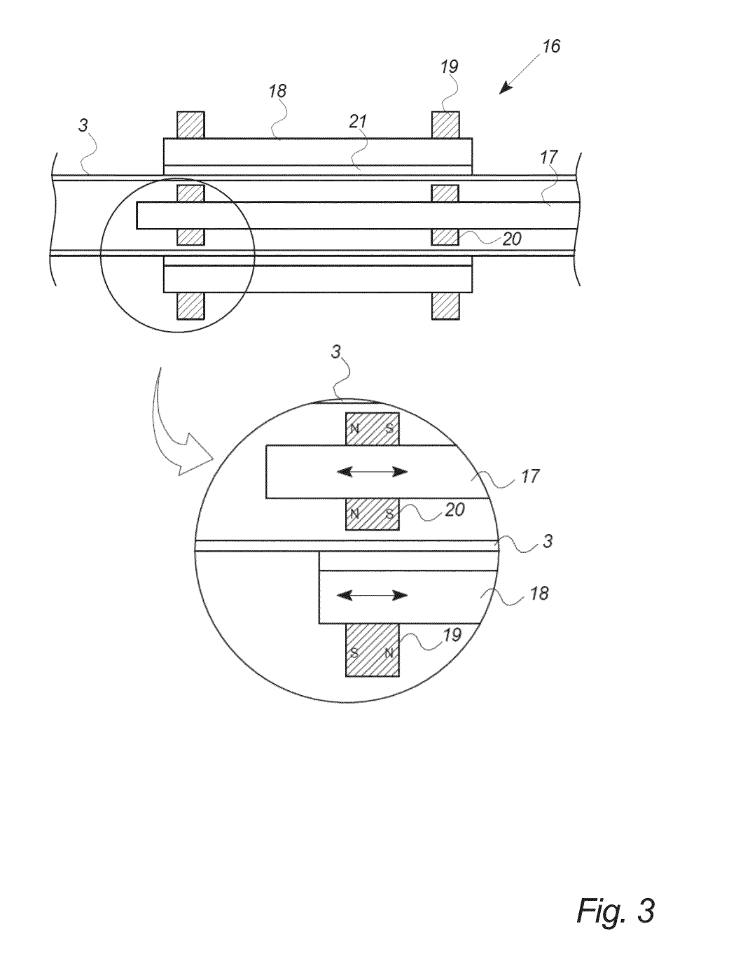

Further, the device 15 is illustrated with control means 16 partly located inside the housing in the liquid flow if and partly located outside the housing as one end of a control rod 17. The control rod continues into the device 5 via a housing opening in proximity of the electric connection 7 for the concentric electrode 3. The electrode 3 is of a hollow construction and the control rod 17 extends in the space inside the electrode. The part of the control rod 17 located inside the electrode 3 is provided with sets of permanent magnets 20 (illustrated in further details in FIG. 3).

FIG. 2 also illustrates a concentric dividing element 18 located on the outside of the electrode 3. The element is provided with sets of permanent magnets 19 and will slide on the electrode 3 in response to movement of the control rod and the accompanying permanent magnets 20 (described in further details in connection with FIG. 3).

The dividing element 18 may slide into the overlapping area between the concentric electrodes 2, 3.

The dividing element 18 is made in an electrically isolating material. The choice of material ensures that the dividing element 18 restricts the ion movement when the element enters into the overlapping area between the concentric electrodes 2, 3 i.e. controls the treatment of the liquid in response to the position of the dividing element 18 and the control rod 17.

In an alternative embodiment, the dividing element 18 is made in an electrically conductive material connected to one side of the AC voltage source 4 and the electrodes 2, 3 are both connected to the other side of the AC voltage source 4. In such embodiment, the dividing element 18 will enhance the ion movement in the liquid instead of restricting the ion movement.

FIG. 3 illustrates enlargements of the control means 16 in the device 15 of FIG. 2.

The upper enlargement of the figure especially illustrates—in a cross sectional view—the part of the control rod 17 inside the hollow electrode 3 and especially illustrates the two sets of permanent magnets 20. On the outside of the electrode 3 is the dividing element 18 located with two sets of permanent magnets 19. The dividing element 18 may slide on the electrode 3 as the element is concentric with a larger radius than the electrode. The difference in radius is illustrated with a displacement space 21 between the dividing element 18 and the surrounded electrode 3.

The lower enlargement further details the relationship between the sets of permanent magnets 19, 20 on the control rod 17 and the dividing element 18. The arrows exemplifies that a movement in or out of the control rod 17 will result in a corresponding sliding movement of the dividing element 18 due to the magnetic field interaction.

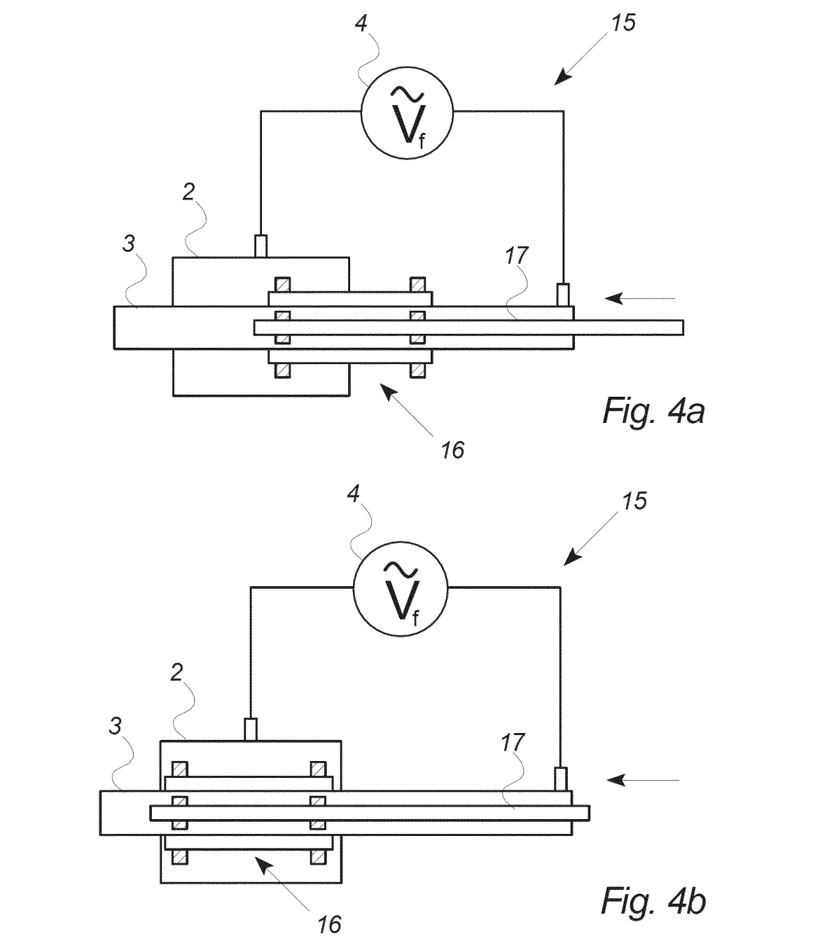

FIGS. 4a and 4b illustrate different positions of the control means in FIG. 2 in relation to the electrodes of the device.

FIG. 4a illustrates the control rod moved from a fully retracted position (illustrated in FIG. 2) to a half entered position wherein the dividing element 18 partly divides/isolates the first electrode 2 from the second electrode 3. Hereby is the control means altered from a position of no control and restriction on the liquid treatment by the device (FIG. 2) to a position of some control and restriction on the liquid treatment (FIG. 4a).

FIG. 4b illustrates the control rod 17 moved to a fully entered position wherein the dividing element 16 totally divides/isolates the first electrode 2 from the second electrode 3. All liquid treatment is stopped by the control means and the liquid will flow untreated through the device until the control rod is more or less retracted again by a user.

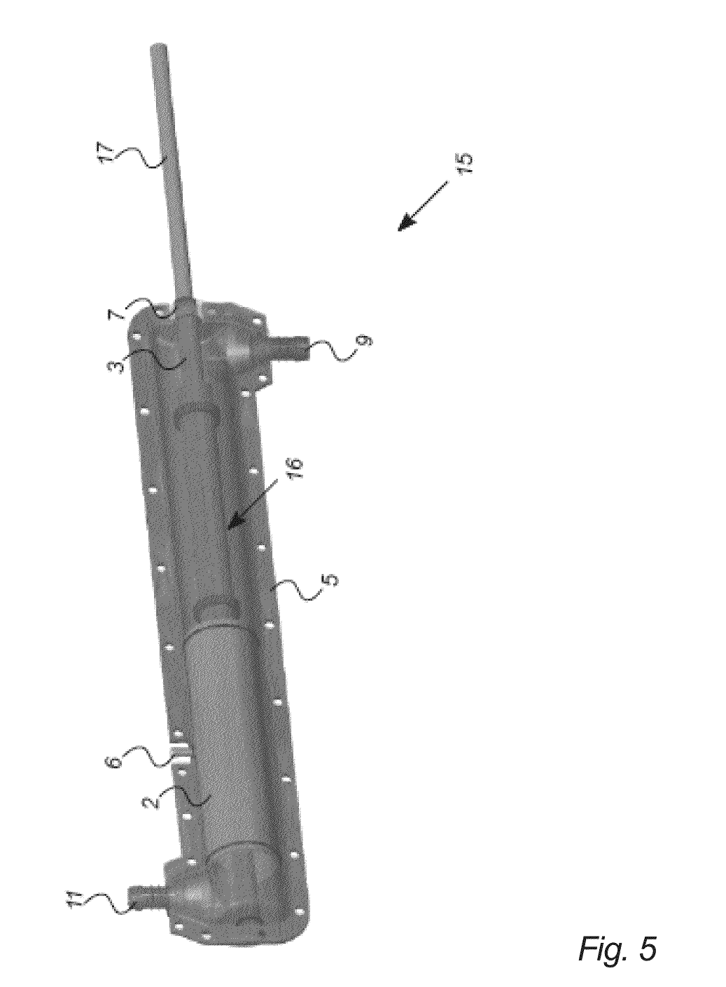

FIG. 5 illustrates a perspective cross sectional view of an embodiment of the device according to the invention for treatment of liquid with control means.

The figure especially illustrates the concentric nature of the electrodes 2, 3 and control means 16 with different radiuses in order to be located inside each other.

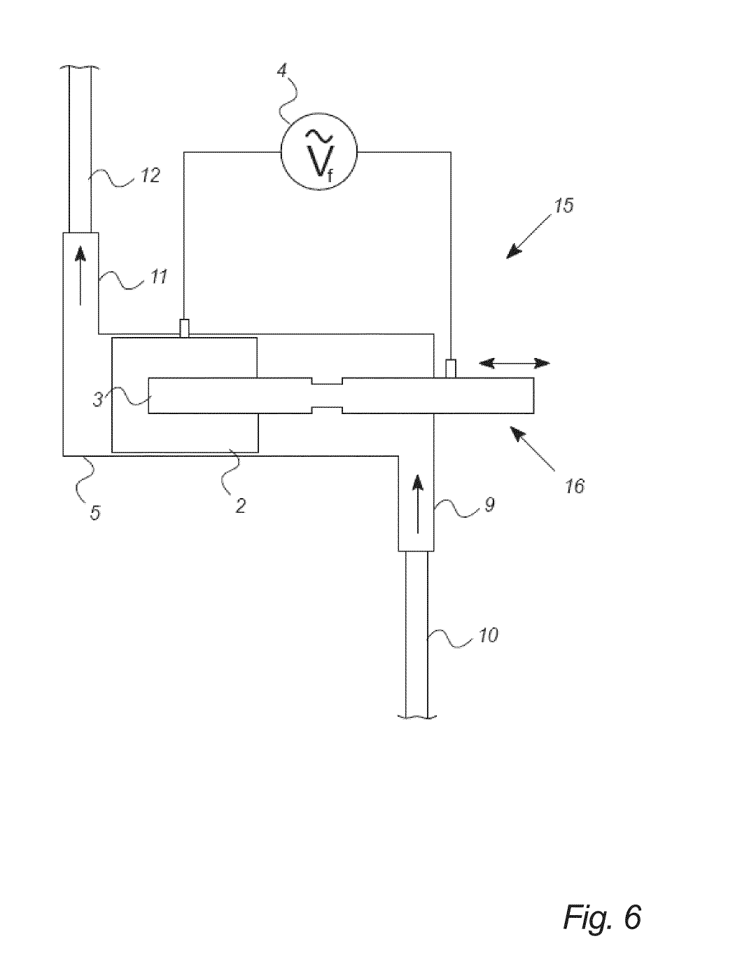

FIG. 6 illustrates an alternative embodiment of the device according to the invention for treatment of liquid.

The first electrode 2 is illustrated as stationary in relation to the second electrode 3 which is moveable inside the housing 5 of the device 15. The figure illustrates schematically how the position of the second electrode 3 is altered by control means 16 attached at one end of the electrode. The control means include a rod which extends out of the housing 5 in order to allow a user to change the position of the electrode 3 in relation to the stationary electrode 2 and hereby control the level of liquid treatment.

The above-mentioned embodiment involves one electrode performing a linear motion in relation to the stationary electrode. However, it should be understood that the invention may also include examples wherein both electrodes are moved in relation to each other in order to control the level of liquid treatment. Further, the electrode may perform a circular motion in relation to each other in order to control the level of liquid treatment in a instead of a linear motion.

Even further, the number of electrodes may be altered from a first and second electrode to a higher number of electrodes e.g. a number of concentric electrodes positioned side by side.

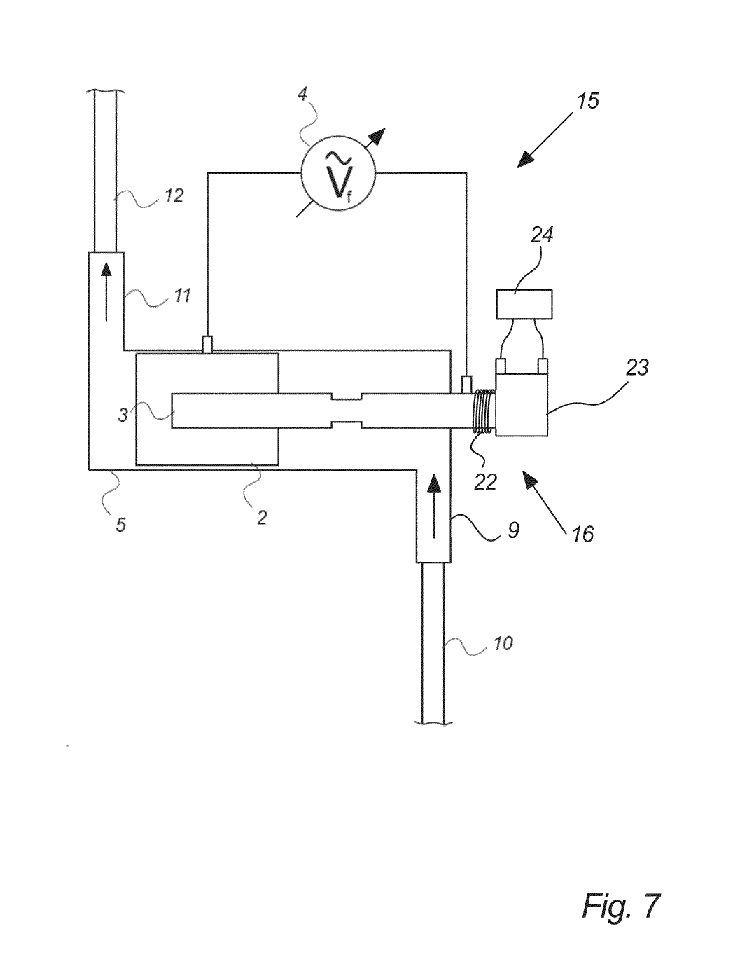

In FIG. 7, the embodiment of FIG. 6 the control means 16 includes a spring 22 arranged to bias the rod out of the housing 5 and a solenoid 23 which may be controlled by the controller 24 to move the rod against the force of the spring 22 towards the housing 5 so as to provide a control system for controlling the level of liquid treatment. The controller 24 may be connected to an external sensor (not shown) for e.g. sensing the temperature of the liquid flowing through the liquid outlet 11 or the discharge pipe 12, whereby the controller 24 is arranged to control the solenoid 23 to obtain a constant temperature of the liquid after treatment. Likewise, an external sensor could be arranged to measure the flow velocity in the liquid inlet 9, the supply pipe 10, the liquid outlet 11 or the discharge pipe 12 and provide an output to the controller 24, which is then arranged to control the solenoid 23 and thereby the level of liquid treatment in response to the flow rate. In another alternative of the embodiment, a measure of the power consumption of the liquid treatment is detected and provided to the controller 24, such as a measure of the electric current through the electrodes 2, 3 and the solenoid 23 is controlled by the controller 24 so as to obtain substantially constant power consumption. In an alternative to the last embodiment, the solenoid 23 is an AC solenoid and is connected in series with the electrodes 2, 3, whereby the position of the rod is controlled directly by the magnitude of the electric current through the electrodes 2, 3 and the controller 24 may be omitted.

The control means 16 of the embodiment of FIG. 7 and as discussed above, i.e. the spring 22, the solenoid 23 and the optional controller 24 may in alternative embodiments of the present invention be applied to control the position of the control rod 17 of the embodiments of FIGS. 2 to 5.

It will also be understood that the invention is not limited to the particular examples described above but may be designed in a multitude of varieties within the scope of the invention, as specified in the claims.

### LIST OF REFERENCE NUMERALS

1. Water treating device

2. First electrode

3. Second electrode

4. AC voltage source

5. Device housing

6-8. Electric connections such as a first and second electric cable/electrode connection and accompanying electric cables

9. Liquid inlet of the device

10. Supply pipe for a device for liquid treatment

11. Liquid outlet of the device

12. Discharge pipe of a device for liquid treatment

13. Liquid in the device housing such as water

14. Electrically charged ions in the liquid

15. Device for liquid treatment

16. Control means

17. Control rod

18. Dividing element

19. Permanent magnets on dividing element

20. Permanent magnets on control rod

21. Displacement between the dividing element and surrounded electrode

22. Spring element

23. Solenoid

24. Controller for the solenoid

lf. Liquid flow in the housing of the device e.g. a drinking water flow

I. Treatment part

II. Control means part

1. A device for treatment of a liquid in a liquid flow system, said device comprising
a housing with at least a liquid inlet and outlet for accompanying a liquid flow through the housing,
at least one AC voltage source alternating at a switch frequency,
at least a first and second electrode for treatment of said liquid and with electric connections to said at least one AC voltage source, and
moveable control means for controlling the level of liquid treatment wherein said at least a first and second electrode and control means are at least partly located in said liquid flow.

2. The device for treatment of a liquid according to claim 1 wherein said control means comprises at least one dividing element made in an electrically isolating material.

3. The device for treatment of a liquid according to claim 1 wherein said control means comprises at least one dividing element made in an electrically conductive material.

4. The device for treatment of a liquid according to claim 2 wherein said dividing element is concentrically surrounding at least a part of one electrode of said at least a first and second electrode.

5. The device for treatment of a liquid according to claim 1 wherein said control means comprises a control rod or a similar moveable device extending out of the housing for controlling the position of said dividing element.

6. The device for treatment of a liquid according to claim 1 wherein one electrode of said at least a first and second electrode is hollow and holding said control rod for interaction with said dividing element via permanent magnets on said rod and/or element.

7. The device for treatment of a liquid according to claim 1 wherein said moveable control means comprises said at least first and second electrode displaceable in relation to each other.

8. The device for treatment of a liquid according to claim 1 wherein said housing is at least separated in a treatment part and a control means part.

9. The device for treatment of a liquid according to claim 1 wherein said control means performs linearly or circularly motions.

10. The device for treatment of a liquid according to claim 1 wherein said switch frequency is a value of at least 10 kHz.

11. The device for treatment of a liquid according to claim 1 comprising an arrangement for controlling the movement of the moveable control means in response to an operational parameter of the device.

12. A method of treating a liquid in a liquid flow system with a device for treatment of liquid according to claim 1, said method comprises the steps of:
providing a path for a liquid flow in the housing of the device via at least a liquid inlet and outlet of the housing,
connecting at least one AC voltage source to at least a first and second electrode for treatment of the liquid in said device, and
controlling the level of liquid treatment with moveable control means,
wherein said at least a first and second electrode and control means are at least partly located in said liquid flow.

13. A through-flow electric liquid heating system or a liquid purification system comprising the device for treatment of a liquid according to claim 1.

14. The device for treatment of a liquid according to claim 3 wherein said dividing element is concentrically surrounding at least a part of one electrode of said at least a first and second electrode.

15. The device for treatment of a liquid according to claim 9 wherein said control means performs a linear sliding motion of said dividing element and/or a circular displacement of said at least a first and second electrode.

16. The device for treatment of a liquid according to claim 10 wherein said switch frequency is approx. 30 kHz.

17. The method of treating a liquid in a liquid flow system according to claim 12, wherein the device for treatment of liquid is a through-flow electric liquid heating system or a liquid purification system.
